(19) United States
(12) Patent Application Publication
(10) Pub. No.: US 2026/0128193 A1
(43) Pub. Date: May 7, 2026

(54) Flexible Cables for Communicating Electrical Signals in a Cryogenic System

(71) Applicant: Rigetti & Co, LLC, Berkeley, CA (US)

(72) Inventor: David Pappas, Boulder, CO (US)

(73) Assignee: Rigetti & Co, LLC, Berkeley, CA (US)

(21) Appl. No.: 19/314,735

(22) Filed: Aug. 29, 2025

Related U.S. Application Data
(63) Continuation of application No. PCT/US2024/018416, filed on Mar. 4, 2024.
(60) Provisional application No. 63/488,370, filed on Mar. 3, 2023.

(51) Int. Cl. H01B 7/04; H01B 7/00; H01B 7/42; H01B 13/00

(52) U.S. Cl. CPC H01B 7/04; H01B 7/0009; H01B 7/421; H01B 13/0036

(57) ABSTRACT

In a general aspect, a flexible cable communicates electromagnetic signals in a cryogenic system. In some aspects, the flexible cable includes a signal layer and a ground layer. The signal layer includes signal lines embedded in adhesive material. Each signal line includes a multilayer structure. The multilayer structure includes a layer of non-superconducting material and a layer of rhenium metal. The ground layer is laminated to the signal layer.

### CROSS-REFERENCE TO RELATED APPLICATIONS

This application claims priority to U.S. Provisional Patent Application No. 63/488,370, filed Mar. 3, 2023, entitled “Flexible Cables for Communicating Electrical Signals in a Cryogenic System.” The above-referenced priority document is incorporated herein by reference in its entirety.

### TECHNICAL FIELD

The following description relates to formation and operation of flexible cables for communicating electrical signals in a cryogenic system.

### BACKGROUND

Quantum computers can perform computational tasks by storing and processing information within quantum states of quantum systems. For example, qubits (i.e., quantum bits) can be stored in and represented by an effective two-level sub-manifold of a quantum coherent physical system. A variety of physical systems have been proposed for quantum computing applications. Examples include superconducting circuits, trapped ions, spin systems and others.

### BRIEF DESCRIPTION OF THE DRAWINGS

FIG. 1 is a block diagram of an example computing environment.

FIG. 2 is a block diagram showing aspects of an example cryostat.

FIG. 3 includes a top view and cross-sectional view diagrams showing aspects of an example flexible cable.

FIG. 4 is a flow chart showing aspects of an example process.

FIG. 5A is an optical image showing aspects of an example flexible cable.

FIG. 5B includes microscopic images and an electron microscopic image showing cross-sectional views of the example flexible cable shown in FIG. 5A.

FIG. 6 is a plot showing the resistance value in Ohms as a function of the temperature in Kelvin.

FIG. 7A is a schematic diagram showing aspects of an example flexible cable.

FIG. 7B is a schematic diagram showing aspects of an example flexible cable.

### DETAILED DESCRIPTION

In some example quantum computing systems, electromagnetic signals (e.g., radio or microwave frequency signals) are used to control and read qubit devices or other types of system components. These signals can be routed from controller and signal hardware through a set of interconnects that link stages of a cryogenic payload (including both DC and microwave components). The payload may include, for example, circulators, isolators, high-frequency filters, DC filters, amplifiers (solid-state low-noise amplifiers and/or Josephson Parametric Amplifiers), etc. In some implementations, the interconnects are flexible cables.

In some aspects of what is described here, a flexible cable includes a signal layer laminated and sandwiched between two ground layers. The signal layer may include multiple signal lines running in parallel and extending between opposite ends of the flexible cable. The signal lines may be implemented, for example, as striplines, micro-strips, or coplanar waveguides. Each ground layer may include a ground plane laminated on a flexible insulating film. In some instances, two neighboring signal and ground layers are separated by a flexible insulating film. The signal lines and the ground planes of the flexible cable may include a multilayer structure with periodic stacks of alternating thin layers of at least two different materials. Each stack can include at least one superconducting material and at least one non-superconducting material. In certain examples, the superconducting material includes rhenium metal. In certain instances, the rhenium metal of the multilayer structure may include an amorphous structure. In some examples, the multilayered structure is formed using electroplating. In some instances, the periodic stacks in the multilayer structure includes at least three stacks of alternating thin layers of gold and rhenium. In some instances, the flexible cable having superconductivity at a cryogenic temperature can be used in a cryogenic system. The flexible cable may be solder-connected to high-density electrical connectors that allow electrical connection of the flexible cable to a quantum processing unit residing on a lowest-temperature thermalization stage.

In some cases, the systems and methods described here can be used to address challenges introduced by the growth in the number of qubits in a quantum computing system. For example, the flexible cable described here can provide a higher density of signal lines at a lower cost than some other types of hardware, in some instances. For another example, the flexible cable may provide a lower thermal load; may be easily assembled and disassembled; and may be compact in size. Other advantages and improvements may be achieved in some cases.

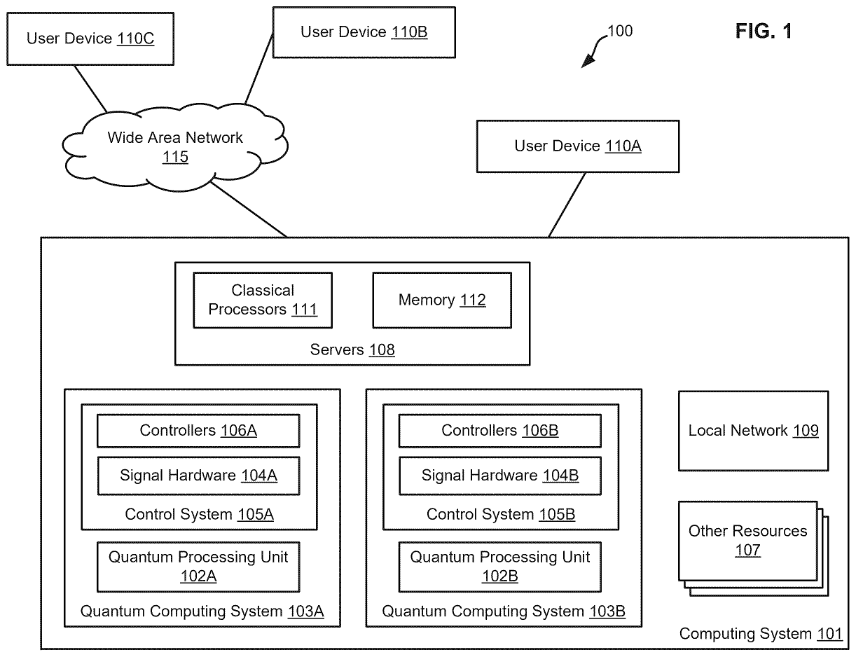

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109 and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109 or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B and the other resources 107 may communicate with each other through the local network 109. In some implementations, the local network 109 operates as a communication channel that provides one or more low-latency communication pathways from the server 108 to the quantum computer systems 103A, 103B (or to one or more of the elements of the quantum computer systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remotely from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115 and possibly other channels. In some implementations, the servers 108 may include a host server, an application server, a virtual server or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media and memory devices, etc.

Each of the example quantum computing systems 103A, 103B operates as a quantum computing resource in the computing system 101. The other resources 107 may include additional quantum computing resources (e.g., quantum computing systems, quantum virtual machines (QVMs) or quantum simulators) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a quantum virtual machine, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or quantum virtual machines. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise). In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases, the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 104 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, the cloud-based QC environment is implemented using a resource such as, for example, OPENSTACK®. OPENSTACK® is an example of a software platform for cloud-based computing, which can be used to provide virtual servers and other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processor units 102A, 102B, and interact with a remote user device (110B or 110C) to provide a user programming environment. The QMI may operate in close physical proximity to and have a low-latency communication link with the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in and represented by an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processor, a quantum memory, or another type of subsystem. In some examples, the quantum processing unit 102A includes a quantum circuit system. The quantum circuit system may include qubit devices, readout devices and possibly other devices that are used to store and process quantum information. In some cases, the quantum processing unit 102A includes a superconducting circuit, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processing unit 102A. In some cases, the quantum processing unit 102A includes an ion trap system, and the qubit devices are implemented as trapped ions controlled by optical signals delivered to the quantum processing unit 102A. In some cases, the quantum processing unit 102A includes a spin system, and the qubit devices are implemented as nuclear, or electron spins controlled by microwave or radio-frequency signals delivered to the quantum processing unit 102A. The quantum processing unit 102A may be implemented based on another physical modality of quantum computing.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

In some implementations, the example quantum processing unit 102 is a modular quantum processing unit that includes multiple quantum processor modules. For example, the quantum processing unit 102 may include a two-dimensional or three-dimensional array of quantum processor modules, and each quantum processor module may include an array of quantum circuit devices. In some cases, the quantum processor modules are supported on a common substrate, and they are interconnected through circuitry (e.g., superconducting circuitry) on the common substrate.

In some instances, each of the quantum processor modules can include a superconducting quantum integrated circuit (QuIC) that includes one or more quantum circuit devices and superconductive lines that connect the one or more quantum circuit devices. For instance, each quantum processor module may include qubit devices, readout resonator devices, tunable-frequency coupler devices, capacitive coupler devices, or other quantum circuit devices. Each quantum processor module may include flux bias control lines, microwave drive lines, readout signal lines, or other types of control lines for providing control signals to respective quantum circuit devices. In some implementations, quantum processor modules can be coupled to each other by inter-chip coupler devices in one or more cap structures.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (e.g., microwave, radio, optical, bias, etc.), electronic systems, vacuum control systems, refrigerant control systems or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computer system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers and other types of components. In some instances, the signal delivery hardware performs preprocessing, signal conditioning, or other operations to the control signals to be delivered to the quantum processing unit 102A. In some instances, signal delivery hardware performs preprocessing, signal conditioning or other operations on readout signals received from the quantum processing unit 102A.

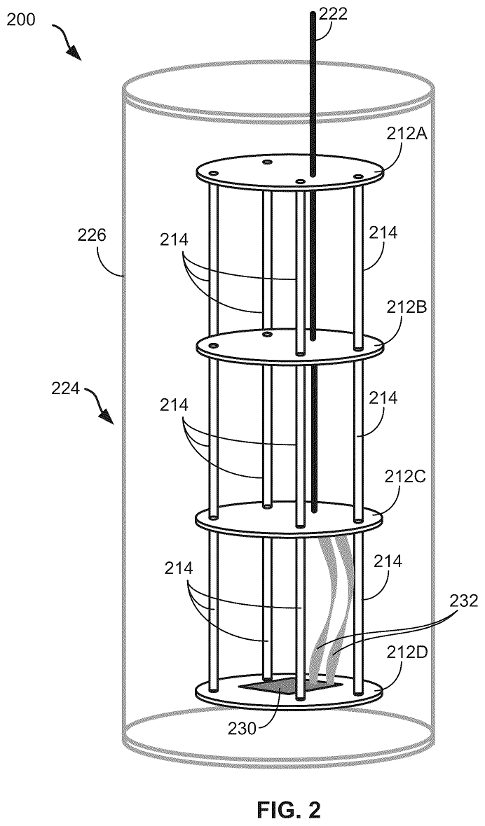

In some implementations, the signal hardware 104A includes a plurality of flexible cables. A flexible cable is configured for communicating electrical signals (or more generally, electromagnetic signals) in a cryogenic system of the quantum processing unit 102A. Each flexible cable includes at least one signal layer and at least one ground layer laminated together. Each of the at least one signal layer includes signal lines; and each of the at least one ground layer includes a ground plane. The signal lines and the ground planes include a multilayer structure that shows superconductivity at a cryogenic temperature. In some instances, the multilayer structure includes periodic stacks of alternating thin films of materials. Each stack of the multilayer structure includes at least one superconducting material and at least one non-superconducting material. The superconducting material includes amorphous rhenium metal; and the non-superconducting material includes at least one of gold, silver, copper, palladium, platinum, or other noble metal. In some instances, the number of rhenium layers in the multilayer structure is determined by the current level at which the flexible cable is designed to operate. The signal lines in a signal layer are separated from the ground plane in a neighboring ground layer by a flexible insulating film. The flexible cable of the signal hardware 104A may be implemented as the example flexible cables 232, 300, 500, 700, 710 in FIGS. 2, 3, 5A-5B, and 7A-7B, or in another manner.

In some embodiments, a flexible cable of the signal hardware 104A is a superconducting flexible cable for low temperatures stages in cryogenic systems. A flexible cable has one or more of the following characteristics, including a critical temperature T_{C}4 K (achievable using electroplated amorphous rhenium metal—see U.S. Pat. Nos. 10,741,742, 11,018,290 and 11,309,478), a low thermal conductivity (due to having thin electrodes), and solderable contacts (due to being able to have a solderable material such as Au on the top surface of the multilayer stack). Note that the low thermal conductivity is achieved by the fact that very thin (less than 1 μm) Au layer can be used in the multilayer electrodes and signal lines and that the thermal conductivity of the superconductor vanishes below the critical temperature. In some instances, a flexible cable may be fabricated with a standard circuit board processing including (1) electroplating of superconducting material with ROHS (Restriction of Hazardous Substances) processes that are compatible with standard circuit board materials such as Au, Cu, Pd, etc. ; and (2) standard copper etch with gold hard mask.

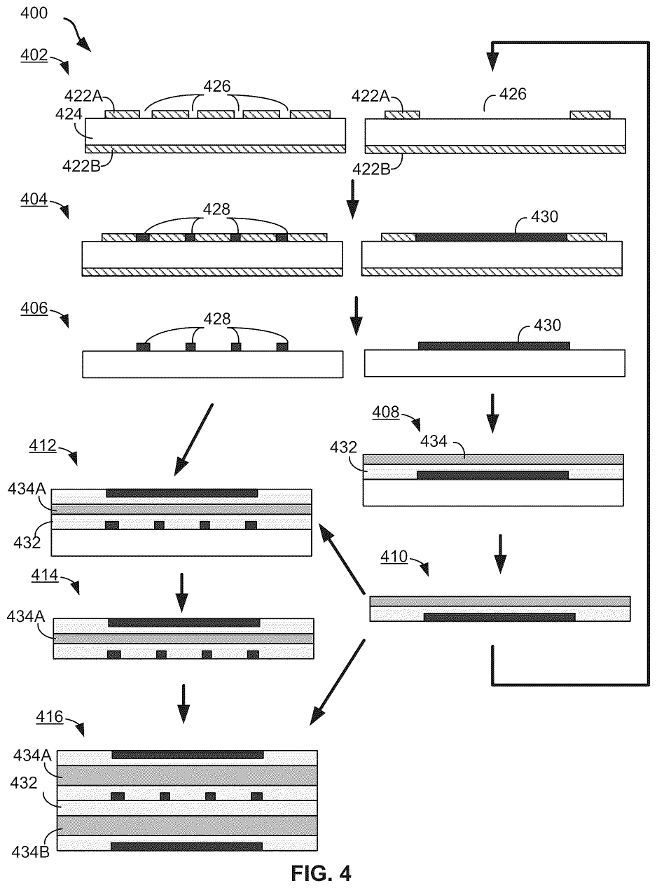

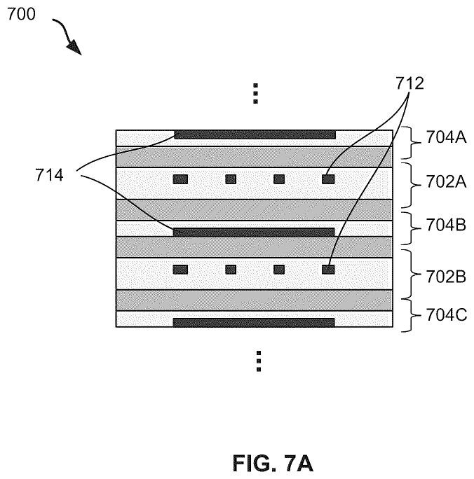

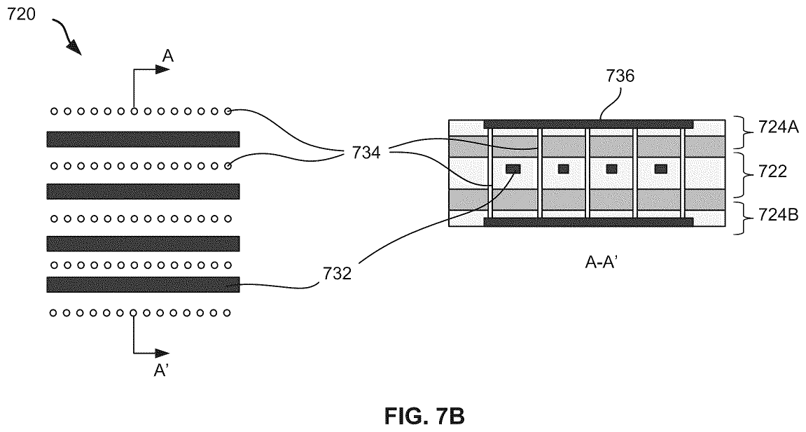

In some implementations, the flexible cable is a low thermal conductivity, superconducting, solderable, electroplated cable. The flexible cable can be made by defining a patterned multilayer structure, e.g., Au/Re, Cu/Re, Pd/Re, or another type of multilayer structure on sacrificial foils, bonding them to polyimide films, and then removing the sacrificial foils. Multiple flexible cables may be bonded together to form cable assemblies (e.g., the example flexible cable 710 as shown in FIG. 7B). In certain instances, a flexible cable of the signal hardware 104A may be fabricated using the operations of the example process 400 in FIG. 4, or in another manner.

In some instances, the flexible cable of the signal hardware 104A is an ultra-high density (1 mm/line) superconducting flexible cable with an impedance of 50 ohm, which can provide low loss and wide-bandwidth, resistance to electromagnetic interference, etc. In some implementations, the flexible cable of the signal hardware 104A can be used for communicating signals to and from the quantum processing unit 102A, for example, from the second lowest-temperature thermalization stage (T=4 K stage) of a dilution refrigerator system down to the lowest-temperature thermalization stage (T=0.010 K stage) in order to scale up cryogenic tests and computations.

The example controllers 106A communicate with the signal hardware 104A to control the operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single-or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computer system 103B and its components (e.g., the quantum processing unit 102B, the signal hardware 104B and controllers 106B) can be implemented as described above with respect to the quantum computer system 103A; in some cases, the quantum computer system 103B and its components may be implemented or may operate in another manner.

In some implementations, the quantum computer systems 103A, 103B are disparate systems that provide distinct modalities of quantum computation. For example, the computer system 101 may include both an adiabatic quantum computer system and a gate-based quantum computer system. As another example, the computer system 101 may include a superconducting circuit-based quantum computer system and an ion trap-based quantum computer system. In such cases, the computer system 101 may utilize each quantum computing system according to the type of quantum program that is being executed, according to availability or capacity, or based on other considerations.

FIG. 2 is a block diagram showing aspects of an example cryostat 200. The example cryostat 200 includes a quantum processing unit 230 supported on a thermalization stage and enclosed in a dilution refrigerator system 224. As shown in FIG. 2, the example dilution refrigerator system 224 includes multiple thermalization stages 212A, 212B, 212C, 212D. In some implementations, the example dilution refrigerator system 224 may be used to expose devices and samples to environments of very low temperature (e.g., T<120 K). In some implementations, vacuum cryostats are used for thermal isolation, typically having a pressure in the range of 10⁻¹ to 10⁻⁷ Pascal, thereby allowing the example dilution refrigerator system 224 to operate at stable temperatures without appreciable thermal losses.

In some implementations, the one or more thermalization stages 212A, 212B, 212C, 212D may correspond to radiation shields, thermalization plates, or both. In some instances, a thermalization stage 212A, 212B, 212C, 212D in the dilution refrigerator system 224 may be formed of a material having a high thermal conductivity at cryogenic temperatures, such as below 120 K. For example, each of the thermalization stages 212A, 212B, 212C, 212D may be formed of a material having a thermal conductivity of at least 1 W/(m·K) as measured at 4 K. In some examples, a high thermal conductivity allows the thermalization stage to mitigate the development of temperature gradients, thereby maintaining a substantially uniform temperature across their respective masses. In some implementations, such material in a thermalization stage may include oxygen-free high conductivity copper and its alloys, including a C101 copper alloy or a beryllium-copper alloy (e.g., Cu with 0.5-3% Be) or another type of alloy.

In some instances, the dilution refrigerator system 224 may include any number of thermalization stages 212 to support subsystems, devices, and samples for cryogenic refrigeration. As a result, the dilution refrigerator system 224 may position the thermalization stages 212 to define a spatial sequence of thermalization stages, such as in a linear sequence. FIG. 2 depicts four thermalization stages 212 in an equally spaced linear sequence. In some implementations, the dilution refrigerator system 224 may include any number and spacing of thermalization stages 212 as needed. In the example shown in FIG. 2, the dilution refrigerator system 224 includes multiple structural supports 214 to position the thermalization stages 212A, 212B, 212C, 212D into the spatial sequence of thermalization stages. In some examples, the structural supports 214 may be formed of a material having a low thermal conductivity at cryogenic temperatures, e.g., less than 0.5 W/(m·K) at or below 50 K, such as a stainless-steel alloy or a glass-epoxy laminate of G10 grade. In this case, the structural supports 214 thus additionally impede a flow of heat between the thermalization stages 212. As such, the dilution refrigerator system 224 may include one or more thermalization stages 212 dedicated to a specific temperature during operation. For example, the dilution refrigerator system 224 may be configured such that each thermalization stage 212 operates at a progressively decreasing temperature as the depth of the dilution refrigerator system 224 increases.

In some implementations, the dilution refrigerator system 224 may also include one or more refrigeration systems (not shown) thermally coupled to each of the thermalization stages 212. For example, the dilution refrigerator system 224 may include a pulse-tube refrigeration system coupled to a second lowest-temperature thermalization stage 212C and a ³He/⁴He dilution refrigerator system thermally coupled to a lowest-temperature thermalization stage 212D. The dilution refrigerator system 224 establishes specific operating temperatures for the thermalization stages 212 to which they are respectively thermally coupled. In some implementations, the dilution refrigerator system 224 may define a distribution of operating temperatures along the spatial sequence of thermalization stages 212. In some implementations, a pulse-tube refrigeration unit may be configured to optimally extract heat at temperatures to about 4 K and a ³He/⁴He dilution refrigerator unit may be configured to optimally extract heat at temperatures below 1 K.

In the example shown in FIG. 2, the quantum processing unit 230 is configured on the lowest-temperature thermalization stage 212D of the dilution refrigerator system 224. In some implementations, the quantum processing unit 230 may receive and transmit signals via flexible cables 232 and transmission links 222. In some instances, the signals communicated on the transmission links 222 and the flexible cables 232 are microwave or radio-frequency frequency signals. As shown in FIG. 2, the transmission links 222 in the dilution refrigerator system 224 are configured separately from the structural supports 214 through the thermalization stages 212.

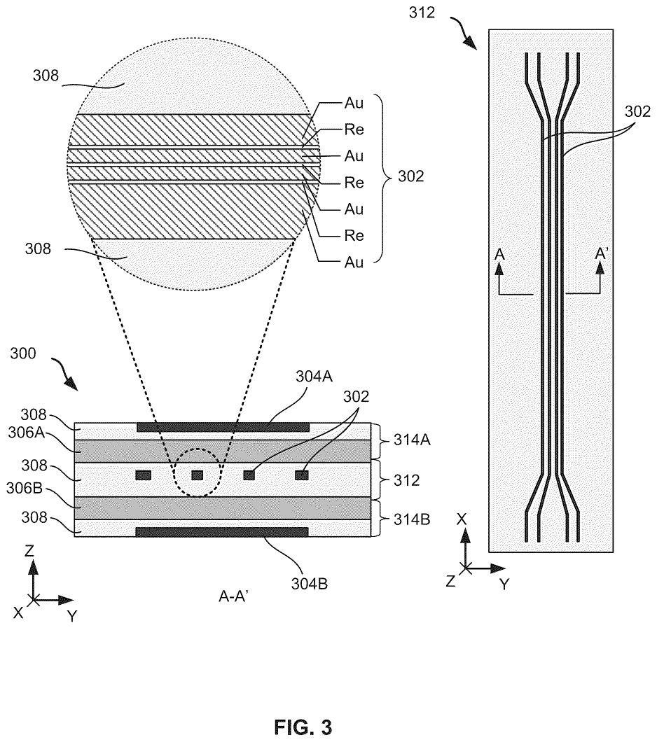

In some implementations, each of the flexible cables 232 has one end thermally anchored to the lowest-temperature thermalization stage 212D which the quantum processing unit 230 resides on and thermalized to; and the other end thermally anchored to the second lowest-temperature thermalization stage 212C. In some instances, each of the flexible cables 232 is superconducting at a cryogenic temperature, e.g., at or below the temperature of the second lowest-temperature thermalization stage 212C. In some instances, each of the flexible cables 232 includes an insulating polymer, plastic films, or another composite material. In some implementations, the flexible cables 232 may be implemented as the example flexible cables 300, 500, 700, 710 as shown in FIGS. 3, 5A-5B, and 7A-7B, and may be fabricated according to the operations in the example process 400 as shown in FIG. 4.

In some implementations, the quantum processing unit 230 includes a superconducting quantum circuit. In certain instances, the superconducting quantum circuit of the quantum processing unit 230 includes quantum circuit devices, such as qubit devices (e.g., transmon devices, fluxonium devices, or other types of superconducting qubit devices), coupler devices, readout resonators, or other types of quantum circuit devices that are used for quantum information processing in the quantum processing unit 230. In some examples, each of the qubit devices in a quantum processing unit 230 can be encoded with a single bit of quantum information. The quantum circuit devices may include one or more Josephson junctions, capacitors, inductors, and other types of circuit elements.

In some implementations, the superconducting quantum circuit on the quantum processing unit 230 may further include a variety of circuit elements to control or readout the qubit devices of the quantum processing unit 230. For example, the superconducting quantum circuit may include flux bias lines which can provide magnetic flux locally to tunable-frequency qubit devices to tune their frequencies. The superconducting quantum circuit may include tunable coupler devices, microwave feedlines, and resonator devices to readout qubits. In some examples, the superconducting quantum circuit may include microwave feedlines which are coupled to one or several of the resonator devices quantum processing unit 230 to allow microwave excitation of the resonator devices used to readout qubits. In this case, the superconducting quantum circuit may include microwave drive lines which are capacitively coupled to qubit devices to drive qubits.

Typically, each of the qubit devices has two eigenstates that are used as computational basis states (e.g., |0) and |1)), and each qubit device can transition between its computational basis states or exist in an arbitrary superposition of its computational basis states. In some examples, the two lowest energy levels (e.g., the ground state and first excited state) of each qubit device are defined as a qubit and used as computational basis states for quantum computation. In some examples, higher energy levels (e.g., a second excited state or a third excited state) can be used to define a qubit, a qutrit, a qudit, or some other multi-level quantum computational device in some instances. Quantum states (e.g., qubits) defined by respective qubit devices can be manipulated by control signals, or read by readout signals, generated by a control system, e.g., the control system 105 in FIG. 1. The qubit devices can be controlled individually, for example, by delivering control signals from a control system to the respective qubit devices. In some cases, readout devices can detect the states of the qubit devices, for example, by interacting directly with the respective qubit devices.

The superconducting quantum circuit in the quantum processing unit 230 shown in FIG. 2 is fabricated on a substrate. In certain instances, the substrate supporting the superconducting quantum circuit may be an elemental semiconductor, for example silicon (Si), germanium (Ge), selenium (Se), tellurium (Te), or another elemental semiconductor. In some instances, the substrate may also include a compound semiconductor such as aluminum oxide (sapphire), silicon carbide (SiC), gallium arsenic (GaAs), indium arsenide (InAs), indium phosphide (InP), silicon germanium (SiGe), silicon germanium carbide (SiGeC), gallium arsenic phosphide (GaAsP), gallium indium phosphide (GaInP), or another compound semiconductor. In some instances, the substrate may also include a multilayer with elemental or compound semiconductor layers. In certain instances, the substrate includes an epitaxial layer. In some examples, the substrate may have an epitaxial layer overlying a bulk semiconductor or may include a semiconductor-on-insulator (SOI) structure.

The superconducting quantum circuit may include superconductive materials and can be formed by patterning one or more superconductive (e.g. superconducting metal) layers or other materials. In some implementations, each of the one or more superconductive layers include a superconducting metal, such as aluminum (Al), niobium (Nb), rhenium (Re), tantalum (Ta), titanium (Ti), vanadium (V), tungsten (W), zirconium (Zr), or another superconducting metal. In some implementations, each of the one or more superconductive layers may include a superconducting metal alloy, such as molybdenum-rhenium (Mo/Re), niobium-tin (Nb/Sn), or another superconducting metal alloy. In some implementations, each of the superconductive layers may include a superconducting compound material, including superconducting metal nitrides and superconducting metal oxides, such as titanium-nitride (TiN), niobium-nitride (NbN), zirconium-nitride (ZrN), hafnium-nitride (HfN), vanadium-nitride (VN), tantalum-nitride (TaN), molybdenum-nitride (MoN), yttrium barium copper oxide (Y—Ba—Cu—O), or another superconducting compound material. In some instances, the superconducting quantum circuit may include multilayer superconductor-insulator heterostructures.

In some implementations, the superconducting quantum circuit is fabricated on the top surface of a substrate and patterned using a microfabrication process or in another manner. For example, quantum circuit devices in a superconducting quantum circuit may be formed by performing at least some of the following fabrication steps: using chemical vapor deposition (CVD), physical vapor deposition (PVD), atomic layer deposition (ALD), spin-on coating, and/or other suitable techniques to deposit respective superconducting layers on the substrate; and performing one or more patterning processes (e.g., a lithography process, a dry/wet etching process, a soft/hard baking process, a cleaning process, etc.) to form openings in the respective superconducting layers.

In some implementations, the quantum processing unit 230 includes multiple quantum processor modules each including qubit devices and other quantum circuit devices in a range of 40 to 100 or more qubit devices and the quantum processing unit 230 may include in the range of 16 to 100 or more quantum processor modules. Consequently, the quantum processing units 410 can operate up to ˜10,000 or more qubit devices. The flexible cables 232 with a high density of signal lines (e.g., in a range of greater than or equal to 0.2 signals/mm² or another range) can be used for communicating electromagnetic signals (e.g., control signals and readout signals) between the quantum circuit devices of the quantum processing unit 230 in the cryostat 200 with a control system outside of the cryostat 200. In some instances, the flexible cable 232 can be used for communicating electrical signals with other types of devices in the cryostat 200. For example, devices and components on the second lowest-temperature thermalization stage 212C may communicate with the flexible cable 232 and the transmission link 222 through respective connectors.

FIG. 3 includes a top view and cross-sectional view diagrams showing aspects of an example flexible cable 300. As shown in FIG. 3, the example flexible cable 300 includes a signal layer 312, a first ground layer 314A, and a second ground layer 314B. The signal layer 312 includes signal lines 302 which are sandwiched between two flexible insulating films 306A, 306B embedded within an adhesive layer 308; each of the first and second ground layers 314A, 314B includes a respective ground plane 304A, 304B laminated on the respective flexible insulating films 306A, 306B embedded in adhesive layers 308. In some implementations, the signal line 302 and the ground planes 304A, 304B show superconductivity at a cryogenic temperature (e.g., equal to or lower than 4 K). In some implementations, the example flexible cable 300 is used in a cryogenic system for communicating high-density electrical signals to and from a quantum processing unit residing on a lowest-temperature thermalization stage of a cryostat of a cryogenic system. The example flexible cable 300 may include additional or different features, and the components of the example flexible cable 300 may operate as described with respect to FIG. 3 or in another manner. In some implementations, the example flexible cable 300 may be fabricated by performing operations in the example process 400, or in another manner.

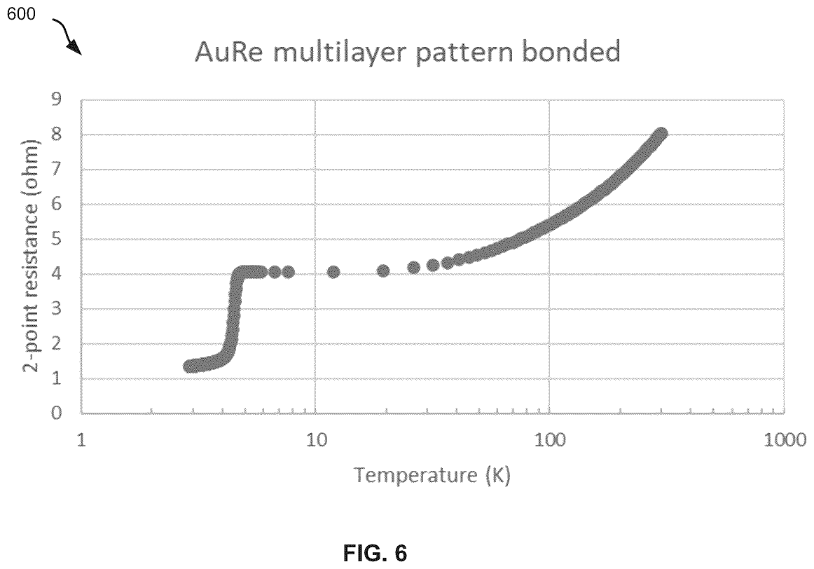

In some implementations, each of the signal lines 302 includes a multilayer structure with periodic stacks of alternating thin layers of two or more different materials. In some implementations, each stack in the multilayer structure includes at least one layer of a superconducting material. In some instances, each stack in the multilayer structure includes a layer of non-superconducting material, which can be used for improving the performance and properties of the superconducting material. As shown in FIG. 3, the multilayer structure includes three stacks of alternative layers of gold and rhenium and a gold termination layer. In some instances, the signal lines 302 with the multilayer structure shows superconductivity at a cryogenic temperature at or below 4 K. An example measured resistance as a function of temperature is shown in FIG. 6. In some instances, the ground plane 304A, 304B may include the same multilayer structure or may have a different structure.

In some instances, the multilayer structure in the ground and signal layer includes a termination layer that is used to cover and protect the end layer of the superconducting material. In this case, the termination layer including at least one noble metal (e.g., copper, silver, gold, nickel, platinum, palladium, etc.), is inert and can be used to stabilize the amorphous nature of the superconducting material in the end layer. In some implementations, the termination layer makes the flexible cable solderable allowing the flexible cable being solder-connected to electrical connectors without significantly affecting the superconductivity and critical temperature of the superconducting material in the multilayer structure. In some instances, the termination layer may be formed on the end layer of the superconducting material using electroplating. In some implementations, the flexible cables can be connectorized with standard high-density connectors using a solder that has a low melting temperature (T<150 C or another range) for relatively short periods of time (t<10 minutes or another time period).

FIG. 4 is a flow chart showing aspects of an example process 400. In some implementations, the example process 400 may be used to fabricate the flexible cable 300, 500, 700, 710 shown in FIGS. 3, 5A-5B, 7A-7B. In particular, operations 402, 404, 406 of the process 400 can be performed to fabricate the signal layer 312 of the flexible cable 300; and operations 402, 404, 406, 408, 410 can be performed to fabricate the ground layers 314A, 314B of the flexible cable 300. The example process 400 may include additional or different operations, including operations to fabricate additional or different components, and the operations may be performed in the order shown or in another order. In some cases, operations in the example process 400 can be combined, iterated, or otherwise repeated or performed in another manner.

At 402, a first photoresist layer 422A is patterned. In some implementations, the first photoresist layer 422A may include a negative or positive tone photoresist layer that is patternable in response to a photolithography light source. In some instances, the first photoresist layer 422A may include an e-beam (electron beam) resist layer (e.g., poly methyl methacrylate, methyl methacrylate, or another e-beam resist material) that is patternable in response to an e-beam lithography energy source. In some examples, before patterning, the first photoresist layer 422A is formed directly on a first surface of a substrate 424 using a deposition process such as spin-coating, spray-coating, dip-coating, roller-coating, or another deposition method. After deposition, the first photoresist layer 422A is then patterned using a lithography process that may involve various exposure, developing, baking, stripping, etching, and rinsing/cleaning processes. As a result, the first photoresist layer 422A is patterned such that openings 426 in the first photoresist layer 422 expose at least a portion of the first surface of the substrate 426. In some implementations, positions of the openings 426 are determined according to the signal lines in the flexible cable. During operation 402, a second photoresist layer 422B may also be formed simultaneously or separately on a second, opposite surface of the substrate 424 to protect the second surface of the substrate 424.

In some instances, prior to the formation of the first photoresist layer 422, the substrate 424 can be prepared. In some implementations, the substrate 424 is a copper foil, or other types of substrates. For example, the substrate 424 may be another type of conductive substrate that is compatible with an electroplating process. In some instances, the copper foil can be cleaned to remove any organic contaminations, particles, or oxides that may have formed on the surface of the substrate 424. For example, when a copper foil is used as the substrate 424, the substrate 424 may be immersed in a solution of diluted sulfuric acid followed by a rinse of deionized water.

At 404, signal lines 428 and a ground plane 430 are formed. In some instances, the signal lines 428 and ground plane 430 are formed by filling the openings 426 in the patterned first photoresist layer 422A with conductive materials. In some implementations, the signal lines 428 and the ground plane 430 include a multilayer structure, which is formed by deposition of alternating thin layers of two or more different materials. In some implementations, the two or more different materials include a superconducting material and a non-superconducting material. In some instances, the multilayer structure of the signal lines 428 and the ground plane 430 includes one or more layers of rhenium metal. Each of the one or more layers of rhenium metal is sandwiched between two layers of non-superconducting material (e.g., between two gold layers). In some implementations, the multilayer structure of the signal lines 428 and the ground plane 430 are formed using electroplating.

In some instances, an electroplating solution for non-superconducting material and rhenium electroplating solution can be prepared. In some instances, a gold electroplating solution includes a gold salt such as gold potassium cyanide dissolved in deionized water. The rhenium electroplating solution includes a rhenium salt such as ammonium perrhenate dissolved in deionized water. The concentrations of the gold salt in the gold electroplating solution and the rhenium salt in the rhenium electroplating solution depend on the desired thickness and morphology of respective thin metal layers, and electroplating time.

For example, an electroplating cell can be configured. The substrate 424 can be mechanically supported on a cathode frame electrically contacting the substrate 424. Gold, titanium, stainless steel, carbon mesh, or other types of conductive materials that are inert in the electroplating solutions can be used as an anode. The cathode frame with the substrate 424 and the anode are first immersed in the electroplating solution of non-superconducting material (e.g., a gold electroplating solution). A direct current (DC) can be applied between the cathode frame and the anode. Once the desired thickness of a first layer of non-superconducting material is obtained (e.g., by monitoring the total charge passed, electroplating time, weight increase on the cathode frame, etc.), the DC current is stopped; and the first layer of non-superconducting layer is formed on the substrate 424 at the openings 426. The cathode frame supporting the substrate 424 can be removed from the electroplating solution, rinsed using deionized water to remove any residual electroplating solution, and dried. In some instances, pulse plating, addition of surfactants, electrolyte flow during plating, or other electroplating techniques can be used as would be known by those skilled in the art of electroplating.

The non-superconducting material-plated substrate 424 is then electroplated in the rhenium electroplating solution. In this case, an anode may include a graphite, carbon cloth, or another type of conductive material that is inert in the rhenium electroplating solution. Once the desired thickness of rhenium is obtained, the DC current is stopped. A first layer of rhenium is formed on the first layer of non-superconducting material at the openings 426. The cathode frame can be removed from the rhenium electroplating solution, rinsed using deionized water to remove any residual rhenium electroplating solution, and dried. In some instances, other electroplating techniques can be used.

Subsequent stacks of alternating thin layers of non-superconducting material and rhenium can be formed by alternating the non-superconducting material and rhenium electroplating processes until a desired number of stacks is achieved. In some implementations, a termination layer of non-superconducting material is electroplated on the periodic stacks. After the signal lines 428 and the ground plane 430 are formed, the substrate 424 can then be unloaded from the cathode frame.

In some instances, the signal lines 428 and the ground plane 430 do not completely fill the openings 426. In other words, the thickness of the signal lines 428 or the ground plane 430 in the openings 426 may be less than the thickness of the photoresist layer 422A. In some instances, the signal lines 428 and the ground planes 430 have a thickness in a range of a few hundred nanometers and a few micrometers. Each thin layer in the multilayer structure has a thickness in a range of a few tens of nanometers to a few micrometers. In some instances, the multilayer structure of the signal lines 428 and the ground plane 430 may be stacked in a different manner (e.g., using different deposition techniques, different masking techniques, etc.); or may include other types of materials (e.g., different superconducting metals or different non-superconducting metals) according to the superconducting properties and their operating temperatures. In some instances, the signal lines 428 and the ground plane 430 may include other types of structures and materials; and may be prepared using different methods.

At 406, after forming the signal lines 428 and the ground plane 430, the photoresist layers 422A, 422B on the substrate 424 are removed. In some instances, the photoresist layers 422A, 422B may be removed by one or more chemical cleaning processes using acetone, 1-Methyl-2-pyrrolidon (NMP), Dimethyl sulfoxide (DMSO), or other suitable removing chemicals. In some examples, the chemicals used may need to be heated to temperatures higher than room temperature to effectively dissolve the photoresist layers 422A, 422B. The selection of the remover is determined by the type and chemical structure of the photoresist layers 422A, 422B, the signal lines 428, and the substrate 424 to assure the chemical compatibility of the signal lines 428 and the ground plane 430 and the substrate 424 with the chemical cleaning process. In some implementations, this chemical cleaning process is then followed by a rinsing process using isopropyl alcohol or another chemical, and then using DI water. After removing the photoresist layer 422A, 422B, portions of the first surface of the substrate 424 are exposed.

At 408, a flexible insulating film 434 is formed on the ground plane 430 and the exposed portion of the first surface of the substrate 424. In some implementations, the flexible insulating film 434 includes polyimide (such as the polyimide material commercially known as Kapton® or Cirlex®). The thickness of the polyimide layer in some embodiments is roughly 0.127 mm, 0.762 mm, or another thickness. In some instances, the flexible insulating film 434 may include other materials, such as liquid crystal polymer (LCP), or other materials. In some instances, an adhesive layer 432 is used to laminate the flexible insulating film 434 on to the ground plane 430 and the exposed portion of the first surface of the substrate 424. In some instances, the adhesive layer 432 includes a pressure sensitive adhesive having a thickness of about 0.127 mm to be cryogenically compatible. In some instances, the adhesive layer 432 may include other adhesive materials. In some implementations, the flexible insulating film 434 is formed on the ground layer 430 and the exposed portions of the first surface of the substrate 424 via the adhesive layer 432 by laminating, spin coating, or in another manner.

At 410, the substrate 424 is removed. When the substrate 424 is a copper foil, the cupper foil can be removed by performing a copper etching process. After the etching process, the first layer of non-superconducting material in the multilayer structure of the ground layer 430 is exposed. In some instances, the first layer of the non-superconducting material in the multilayer structure is inert to the copper etching process and can protect the rhenium layer from being attacked by the copper etching process. In some instances, the substrate 424 may be removed using other processes. After removing the substrate 424, the ground plane 430 is supported on a first side of the flexible insulating film 434. In some implementations, operations 402, 404, 406, 408, 418 can be repeated to form distinct flexible insulating films 434 with ground planes 430.

At 412, a first flexible insulating film 434A is bonded to the signal lines 428 and the exposed portion of the first surface of the substrate 424. In some instances, a second opposite side of the flexible insulating film 434 can be formed on the signal lines 428 and the exposed portion of the first surface of the substrate 424 via an adhesive layer 432 by lamination, e.g., applying heat and pressure.

At 414, the substrate 424 is removed. In some instances, the operation 414 is performed according to the operation 410. After the etching process, the first layer of non-superconducting material in the multilayer structure of the signal layer 428 is exposed. After removing the substrate 424, the signal lines 428 are supported on the second side of the first flexible insulating film 434A.

At 416, the flexible cable is formed by laminating a second flexible insulating film 434B with a ground plane to the exposed signal lines 428 such that the signal lines 428 are sandwiched between the first flexible insulating layer 434A and the second flexible insulating layer 434B. As shown in FIG. 4, the second flexible insulating film 434B is laminated to the side of the first flexible insulating film 434A with the exposed first layer of non-superconducting material of the signal lines 428 via an adhesive layer 432 using lamination. In some instances, the second flexible insulating film 438B with a ground plan can be bonded in another manner.

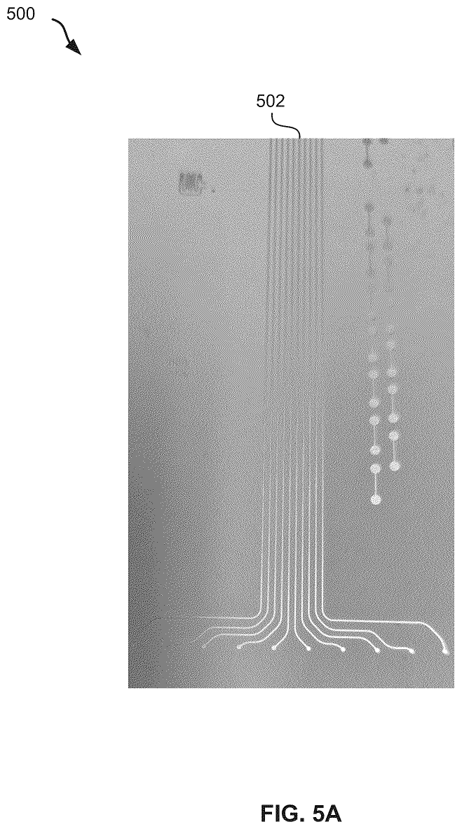

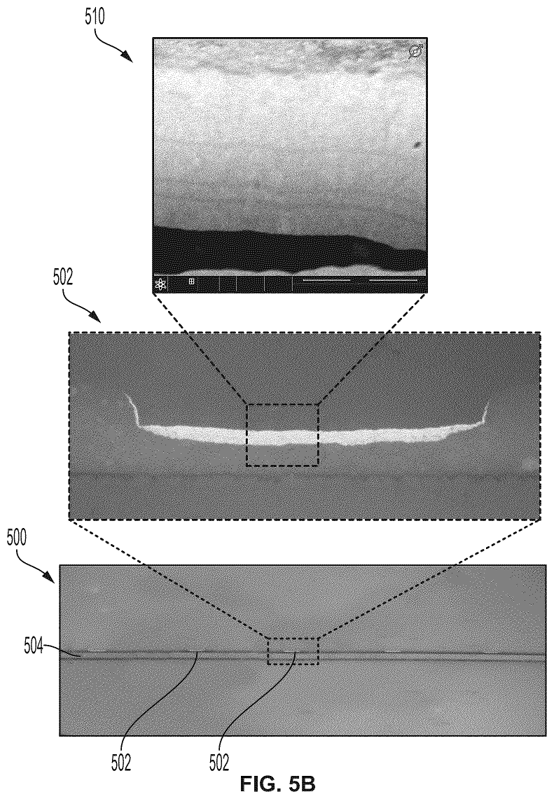

FIG. 5A is an optical image showing aspects of an example flexible cable 500. The example flexible cable 500 includes signal lines 502 supported on a flexible insulating film 504. FIG. 5B includes optical microscope images and an electron microscope image showing cross-sectional views of the example flexible cable 500 shown in FIG. 5A. The flexible insulating film 504 may be a polyimide film, or another composite material. Each of the signal lines 502 includes a multilayer structure which includes 3 stacks of alternating thin layers of gold and rhenium. Each thin layer of rhenium has a thickness in a range of a few tens to a hundred nanometers, and each thin layer of gold has a thickness in a range of a few hundred nanometers to a few micrometers. One of the signal lines 502 showed a total thickness of a few micrometers.

FIG. 6 is a plot 600 showing the resistance value in Ohms as a function of the temperature in Kelvin. As shown in FIG. 6, the multilayer structure exhibits a transition from a normal conducting state to a superconducting state; and demonstrates superconductivity at a cryogenic temperature at or below 4 K.

FIG. 7A is a schematic diagram showing aspects of an example flexible cable 700. As shown in FIG. 7A, the example flexible cable 700 includes multiple signal layers 702A, 702B and multiple ground layers 704A, 704B, 704C with two neighboring signal layers separated by a ground layer. Each signal layer 702A, 702B includes signal lines 712; and each ground layer 704 includes a ground plane 714. The signal layers 702A, 702B and the ground layers 704A, 704B, 704C have a multilayer structure which includes at least a layer of superconducting material and at least one layer of a non-superconducting material. The signal lines 712 and the ground plane 714 are superconducting at or below a cryogenic temperature of around 4 K. In some instances, each signal line 712 defined in the signal layers 702A, 702B of the example flexible cable 700 may be implemented as the one shown in FIGS. 3, 5A-5B, and may be connected to electrical connectors or other components through conductive vias allowing one end of the flexible cable 700 to be electrically connected to a quantum processing unit and to be thermally bonded to a lowest-temperature thermalization stage where the quantum processing unit resides. In some instances, the flexible cable 700 may be formed by laminating two or more flexible cables 300 to one another.

FIG. 7B is a schematic diagram showing aspects of an example flexible cable 720. As shown in FIG. 7B, the example flexible cable 720 includes multiple conductive vias 734 between neighboring signal lines 732. The conductive vias 734 are galvanically connected to the two ground planes 736 in two neighboring ground layers 724A, 724B. In some instances, via holes can be formed by laser drilling or photolithography with a hard mask. The via holes can be filled by electroplating (e.g., operation 404 in the example process 400 shown in FIG. 4), or other processes such as physical vapor deposition, sputter deposition, chemical vapor deposition, electroless plating, etc. In some implementations, each conductive via 734 has a multilayer structure which includes at least one layer of a superconducting material and at least one layer of a non-superconducting material. For example, the multilayer structure of the conductive via 734 may be implemented as the multilayer structure of the signal line 732 or the ground plane 736. In some instances, the non-superconducting material may include a noble metal such as copper, copper alloys, gold, platinum, silver, nickel, nickel alloys, etc. ; and the superconducting material may include rhenium metal. In some instances, the superconducting material may include aluminum, niobium, rhenium alloys, etc.

In a general aspect, a flexible cable is formed and operated for communicating electromagnetic signals in a cryogenic system.

In a first example, a flexible cable for communicating signals in a cryogenic system includes a signal layer and a ground layer. The signal layer includes signal lines embedded in adhesive material. Each signal line includes a multilayer structure including a layer of non-superconducting material and a layer of rhenium metal. The ground layer is laminated to the signal layer.

Implementations of the first example may include one or more of the following features. The non-superconducting material includes a noble metal. The noble metal includes gold. The multilayer structure includes a termination layer. The termination layer includes a layer of gold. The noble metal includes one or more of copper, silver, nickel, platinum, or palladium. The ground layer includes a multilayer structure including a layer of non-superconducting material and a layer of rhenium metal.

Implementations of the first example may include one or more of the following features. The ground layer is a first ground layer. The flexible cable includes a second ground layer laminated to the signal layer, such that the signal layer resides between the first and second ground layers. The flexible cable includes a plurality of conductive vias extending through the signal layer and the first and second ground layers. The plurality of conductive vias pass between neighboring signal lines in the signal layer. Each of the plurality of conductive vias includes a multilayer structure which includes a layer of non-superconducting material and a layer of rhenium metal.

Implementations of the first example may include one or more of the following features. The ground layer is laminated to the signal layer via a flexible insulating film. The flexible insulating film includes polyimide. The rhenium metal has an amorphous structure. The signal layer is a first signal layer. The flexible cable includes a second signal layer. The ground layer is laminated between the first and second signal layers.

In a second example, a flexible cable for communicating signals in a cryogenic system includes first and second ground layers and a signal layer. Each of the first and second ground layers includes a ground plane and insulating material. The signal layer is configured between the first and second ground layers. The signal layer includes signal lines and adhesive material. Each signal line includes at least one layer of non-superconducting material and at least one layer of amorphous superconducting material.

Implementations of the second example may include one or more of the following features. The signal layer includes first and second adhesive layers including the adhesive material; and the signal lines reside in the first adhesive layer. Each signal line includes a signal line stack including superconducting layers made of the amorphous superconducting material and non-superconducting layers made of the non-superconducting material. Each signal line stack alternates between the superconducting layers and the non-superconducting layers. The amorphous superconducting layers in each signal line stack are rhenium layers. The non-superconducting layers in each signal line stack are gold layers. Each signal line stack includes at least three of the rhenium layers.

Implementations of the second example may include one or more of the following features. Each ground plane includes at least one layer of the non-superconducting material and at least one layer of the amorphous superconducting material. Each ground plane includes a ground plane stack including superconducting layers made of the amorphous superconducting material and non-superconducting layers made of the non-superconducting material. The amorphous superconducting layers in each ground plane stack are rhenium layers. The non-superconducting layers in each ground plane stack are gold layers. Each ground plane stack includes at least three of the rhenium layers.

Implementations of the second example may include one or more of the following features. The flexible cable includes a first flexible film layer between the first ground layer and the signal layer; and a second flexible film layer between the second ground layer and the signal layer. The ground plane in the first ground layer is separated from the first flexible film layer by the insulating material in the first ground layer; and the ground plane in the second ground layer is separated from the second flexible film layer by the insulating material in the second ground layer. The flexible cable includes a first end and a second, opposite end. The signal layer includes at least four of the signal lines that run in parallel between the first and second ends of the flexible cable. The signal layer is a first signal layer, and the flexible cable includes a third ground layer including a ground plane and insulating material; and a second signal layer between the second and third ground layers. The second signal layer includes signal lines and adhesive material.

In a third example, a method for fabricating a flexible cable configured for communicating signals in a cryogenic system including forming a signal layer which includes signal lines embedded in an adhesive material; and laminating a ground layer to the signal layer. Forming the signal layer includes forming a multilayer structure of each signal line. The multilayer structure of each signal line includes a layer of non-superconducting material and a layer of rhenium metal.

Implementations of the third example may include one or more of the following features. Forming the multilayer structure includes electroplating the layer of non-superconducting material on a surface of a substrate; and electroplating the layer of rhenium metal on the layer of non-superconducting material. The layer of non-superconducting material is a first layer, and the method includes electroplating a second layer of non-superconducting material on the layer of rhenium metal. The substrate is a first substrate. The method includes forming a ground layer on a surface of a second substrate; attaching the ground layer to a first surface of a flexible insulating film via an adhesive layer including the adhesive material; and removing the second substrate to expose the second, opposite surface of the flexible insulating film. Laminating the ground layer to the signal layer includes attaching the second, opposite surface of the flexible insulating film to the signal layer via a second adhesive layer including the adhesive material; and removing the second substrate.

In a fourth example, a quantum computing system includes a quantum processing unit component, a control system, and a cryogenic system. The quantum processing unit component is configured to operate in a cryogenic environment. The control system is configured to operate outside the cryogenic environment. The cryogenic system is configured to provide the cryogenic environment. The cryogenic system includes a flexible cable configured to communicate signals between the control system and the quantum processing unit component. The flexible cable includes a signal layer and a ground layer. The signal layer includes signal lines embedded in adhesive material. Each signal line includes a multilayer structure which includes a layer of non-superconducting material and a layer of rhenium metal. The ground layer is laminated to the signal layer.

Implementations of the fourth example may include one or more of the following features. The non-superconducting material includes a noble metal. The noble metal includes gold. The noble metal includes one or more of copper, silver, nickel, platinum, or palladium. The ground layer includes a multilayer structure which includes a layer of non-superconducting material and a layer of rhenium metal. The rhenium metal has an amorphous structure.

Implementations of the fourth example may include one or more of the following features. The ground layer is a first ground layer. The flexible cable includes a second ground layer laminated to the signal layer, such that the signal layer resides between the first and second ground layers. The flexible cable includes a plurality of conductive vias extending through the signal layer and the first and second ground layers. The plurality of conductive vias pass between neighboring signal lines in the signal layer. Each of the plurality of conductive vias includes a multilayer structure which includes a layer of non-superconducting material and a layer of rhenium metal.

Implementations of the fourth example may include one or more of the following features. The ground layer is laminated to the signal layer via a flexible insulating film. The flexible cable is connected to one or more electrical connectors and the quantum processing unit component is communicably coupled to the flexible cable via the one or more electrical connectors. The quantum processing unit component resides on a lowest-temperature thermalization stage of the cryogenic system. The flexible cable is thermally anchored between the lowest-temperature thermalization stage and a second lowest temperature thermalization stage such that the flexible cable is thermalized to the lowest-temperature thermalization stage on a first end; and thermalized to the second lowest-temperature thermalization stage of the cryogenic system on a second, opposite end. The cryogenic system includes a transmission link between at least two of the plurality of thermalization stages. The transmission link is configured to communicate the signals between the control system and the flexible cable. thermalization stage

In a fifth example, a cryogenic system with one or more flexible cables for communicating signals with a quantum processing unit, each flexible cable includes a signal layer and a ground layer laminated to the signal layer. The signal layer includes signal lines embedded in adhesive material. Each signal line includes a multilayer structure which includes a layer of non-superconducting material and a layer of rhenium metal.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A flexible cable for communicating signals in a cryogenic system, the flexible cable comprising:
a signal layer comprising signal lines embedded in adhesive material, each signal line comprising a multilayer structure comprising a layer of non-superconducting material and a layer of rhenium metal; and
a ground layer laminated to the signal layer.

2. The flexible cable of claim 1, wherein the non-superconducting material comprises a noble metal.

3. The flexible cable of claim 2, wherein the noble metal comprises gold.

4. The flexible cable of claim 2, wherein the multilayer structure comprises a termination layer.

5. The flexible cable of claim 4, wherein the termination layer comprises a layer of gold.

6. The flexible cable of claim 2, wherein the noble metal comprises one or more of copper, silver, nickel, platinum, or palladium.

7. The flexible cable of claim 1, wherein the ground layer comprises a multilayer structure comprising a layer of non-superconducting material and a layer of rhenium metal.

8. The flexible cable of claim 1, wherein the ground layer is a first ground layer, the flexible cable comprises a second ground layer laminated to the signal layer, such that the signal layer resides between the first and second ground layers.

9. The flexible cable of claim 8, comprising:
a plurality of conductive vias extending through the signal layer and the first and second ground layers.

10. The flexible cable of claim 9, wherein the plurality of conductive vias pass between neighboring signal lines in the signal layer.

11. The flexible cable of claim 9, wherein each of the plurality of conductive vias comprises a multilayer structure comprising a layer of non-superconducting material and a layer of rhenium metal.

12. The flexible cable of claim 1, wherein the ground layer is laminated to the signal layer via a flexible insulating film.

13. The flexible cable of claim 12, wherein the flexible insulating film comprises polyimide.

14. The flexible cable of claim 1, wherein the rhenium metal has an amorphous structure.

15. The flexible cable of claim 1, wherein the signal layer is a first signal layer, the flexible cable comprises a second signal layer, the ground layer is laminated between the first and second signal layers.

16-26. (canceled)

27. A method of fabricating a flexible cable configured to communicate signals in a cryogenic system, the method comprising:
forming a signal layer comprising signal lines embedded in an adhesive material, wherein forming the signal layer comprises forming a multilayer structure of each signal line, the multilayer structure of each signal line comprising a layer of non-superconducting material and a layer of rhenium metal; and
laminating a ground layer to the signal layer.

28. The method of claim 27, wherein forming the multilayer structure comprises:
electroplating the layer of non-superconducting material on a surface of a substrate; and
electroplating the layer of rhenium metal on the layer of non-superconducting material.

29. The method of claim 28, wherein the layer of non-superconducting material is a first layer, and the method comprises:
electroplating a second layer of non-superconducting material on the layer of rhenium metal.

30. The method of claim 28, wherein the substrate is a first substrate, and the method comprises:
forming a ground layer on a surface of a second substrate;
attaching the ground layer to a first surface of a flexible insulating film via an adhesive layer comprising the adhesive material; and
removing the second substrate to expose the second, opposite surface of the flexible insulating film.

31. The method of claim 30, wherein laminating the ground layer to the signal layer comprises:
attaching the second, opposite surface of the flexible insulating film to the signal layer via a second adhesive layer comprising the adhesive material; and
removing the second substrate.

32-45. (canceled)

46. A cryogenic system with one or more flexible cables for communicating signals with a quantum processing unit, each flexible cable comprising:
a signal layer comprising signal lines embedded in adhesive material, each signal line comprising a multilayer structure comprising a layer of non-superconducting material and a layer of rhenium metal; and
a ground layer laminated to the signal layer.
